(19) United States
(12) Patent Application Publication
(10) Pub. No.: US 2011/0113425 A1
(43) Pub. Date: May 12, 2011

(54) Systems And Methods For Making Software Available For Download

(76) Inventors: Adrian L. Tuttle, Houston, TX (US); Luhit L. Young, Cypress, TX (US); Tammy J. Schapiro, Bellaire, TX (US); Jacob B. Hernandez, Houston, TX (US); Kerry J. Bourque, Houston, TX (US); Lorri L. Jefferson, Tomball, TX (US); Anthony Camilli, Cypress, TX (US)

(21) Appl. No.: 12/992,239

(22) PCT Filed: May 13, 2008
(86) PCT No.: PCT/US08/63508

§ 371 Date: Nov. 11, 2010

(51) Int. Cl. G06F 9/445

(52) U.S. Cl. 717/178

(57) ABSTRACT

In one embodiment, a system and method for providing software involve compiling software available for download in a database, prompting a user to select a product for which software is sought, receiving the user product selection, and presenting to the user software available for download, the software being intended for installation on the product that the user selected.

### BACKGROUND

Computers, such as server computers, desktop computers, notebook computers, blades, and the like, are sold with various installed software that enables operation of the computer and its interaction with other devices. From time to time, the computer user may wish to download additional software for the computer. Such additional software may take the form of an update that improves upon original software that was installed on the computer. Alternatively, the additional software may take the form of a software patch that remedies a problem with the original software. In a further scenario, the additional software may comprise new software needed to perform new tasks, such as operate and control a newly purchased peripheral device.

Today, such additional software is typically obtained via the Internet. For example, the computer user may visit a web site hosted by the computer manufacturer and search the site to determine whether the desired software is available for download from the web site. Unfortunately, it is often difficult for such users to obtain the software they need from such web sites. In some cases, the users simply cannot locate the software on the web site. Although such web sites often comprise a search feature that enables the user to search the web site by the computer model, the results of such a search may produce various information that is not relevant, thereby making it more difficult to identify the desired software. In other cases, the web site may not even comprise the software the user is seeking, even if it exists. Such a scenario may occur when the web site is managed by a business unit of the manufacturer that is other than the business unit that develops the additional software.

### BRIEF DESCRIPTION OF THE DRAWINGS

The disclosed systems and methods can be better understood with reference to the following drawings. The components in the drawings are not necessarily to scale.

FIG. 1 is a block diagram of an embodiment of a system with which software can be obtained for various products.

FIG. 2 is a block diagram of an embodiment of storage memory for one or more manufacturer computers shown in FIG. 1.

FIGS. 3-20 are screen shots of a user interface of a download manager program identified in FIG. 2.

FIG. 21 is a flow chart of an embodiment of a method for locating and downloading product software.

FIG. 22 is a flow chart of an embodiment of a method for providing product software for download.

### DETAILED DESCRIPTION

As described above, it can be difficult for product users to obtain software for their products from a product manufacturer. As described in the following, however, such software can be more easily located and downloaded when all of the product software available for download is contained within a single database that can be accessed with a software download manager program specifically designed for use with the database. In some embodiments, the software in the database is accessible via a file transfer protocol (FTP) site with which the user interacts using the download manager program.

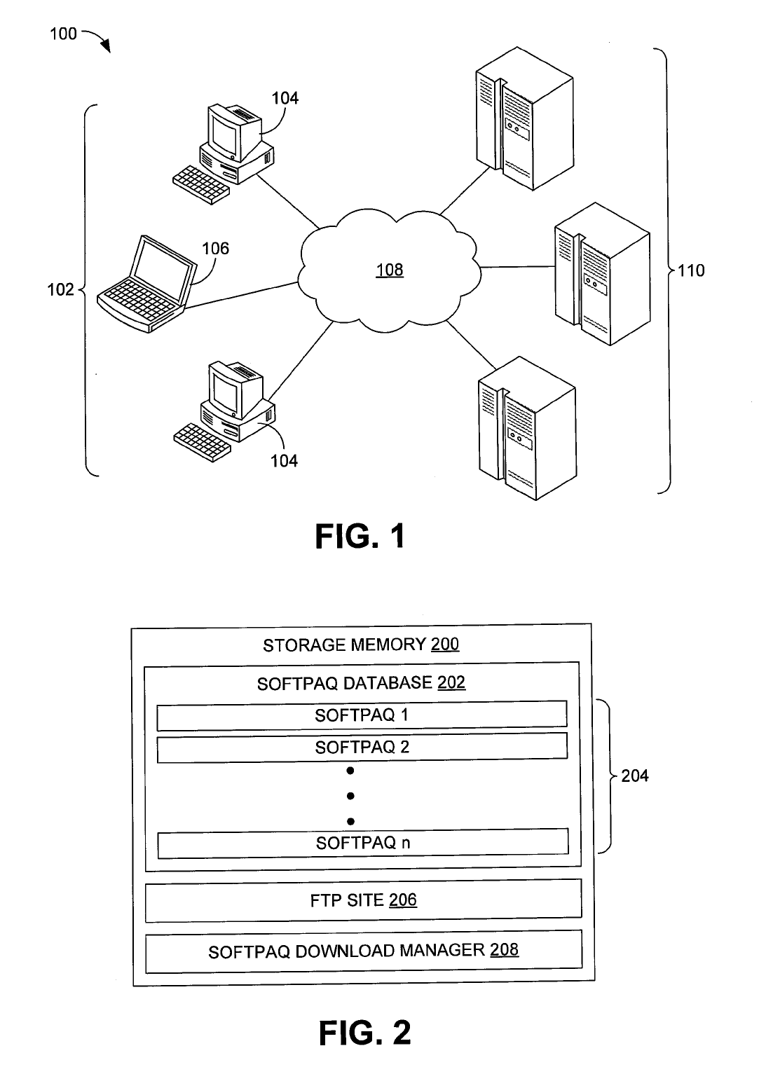

Referring now in more detail to the drawings in which like numerals indicate corresponding parts throughout the views, FIG. 1 Illustrates a system 100 comprising multiple user computers 102. As indicated in the figure, the user computers 102 can take different forms, such as desktop computers 104 and notebook computers 106. Regardless, each user computer 102 comprises a processor and memory from which programs can be executed. In some cases, the user computers 102 comprise the computers of unaffiliated individuals. In such a case, each computer user may be seeking software only for his own computer 102 or another product. In other cases, the user computers 102 can comprise the computers of a given organization, such as a business. In such a case, the computers 102 can be connected to a common local area network (LAN) or wide area network (WAN) (not shown) and the user may be an information technology (IT) manager that is seeking software for one or multiple computers or other products of the organization.

With further reference to FIG. 1, each user computer 106 is connected to a WAN 108, which comprises part of the Internet. Also connected to the WAN 108 are further computers 110 that are maintained by or on the behalf of a manufacturer of products for which software is to be made available. As with the user computers 102, the manufacturer computers 110 may be connected to a common network such as LAN or WAN (not shown). As described below, the manufacture computers 110 individually or collectively maintain a database of software that can be downloaded via an FTP site.

FIG. 2 illustrates an embodiment for the contents of storage memory 200 of the manufacturer computers 110 shown in FIG. 1. As indicated in FIG. 2, the memory 200 stores a SoftPaq database 202 that comprises multiple executable software packages 204, which also referred to herein as “SoftPaqs.” By way of example, the database 202 comprises an extensible mark-up language (XML) database. The software packages 204 contained within the database 202 can comprise any software for products (e.g., computers) that the manufacturer produces or has produced. Therefore, the software packages 204 can comprise software updates, software patches, entire software programs, and the like. In some embodiments, the database 202 is comprehensive and therefore comprises substantially every software package available for download for substantially every software-based product the manufacturer has produced over the last several (e.g., 3-5) years. In such cases, the database 202 comprises a single central location that a user can search for any such software, thereby obviating the need for the user to spend time searching the manufacturer's web site for that software. It is noted that although the term “software” is used herein, that term is intended as an inclusive term that generally refers to both software and firmware, which may also be made available for download.

Also stored within memory 200 stores an FTP site program 206 that can be used to access the software of the database 202 and enable download of that software over the WAN 108 (FIG. 1). Such download is further facilitated by a SoftPaq download manager 208 that is intended for download to and execution on the user's computer 102. In some embodiments, the download manager 208 is made available for download on the manufacturer's web site. Given that the download manager 208 is configured for interaction with the FTP site program 206, the download manager therefore may be described as an FTP client program. Once installed and executed on the user computer 102, the download manager 208 obtains information contained in the database 202 and presents the user with a user interface described in the following that assists the user in locating and downloading software contained in the database.

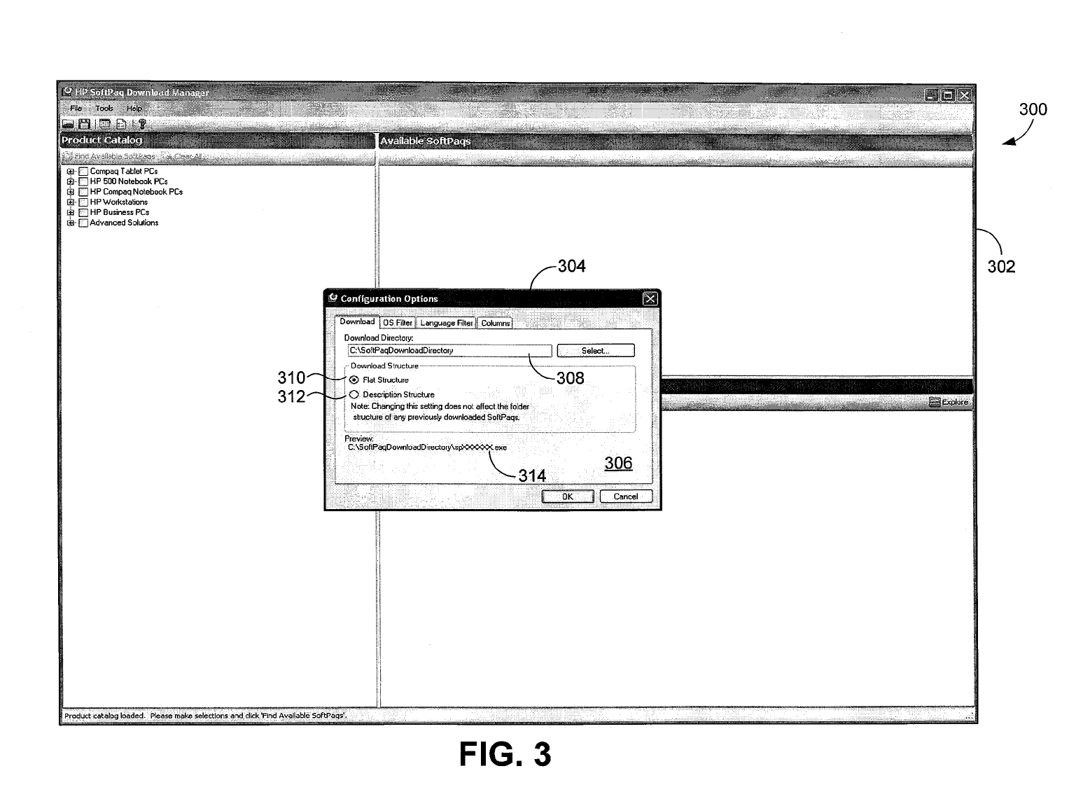

As described above, the SoftPaq download manager 208 can, for example, be made available to users for download from a web site hosted by or on the behalf of the product manufacturer. Once the download manager 208 has been downloaded, the download manager can be installed and executed on the user computer. When executed, a user interface, such as graphical user interface 300 shown in FIG. 3, is presented to the user. As indicated in FIG. 3, the user interface 300 comprises a main window 302, various attributes of that window being described below. If the download manager 208 is being executed for the first time, a configuration options dialog box 304 is presented to the user that requests the user to specify configuration information pertinent to the product or products for which the user is seeking software.

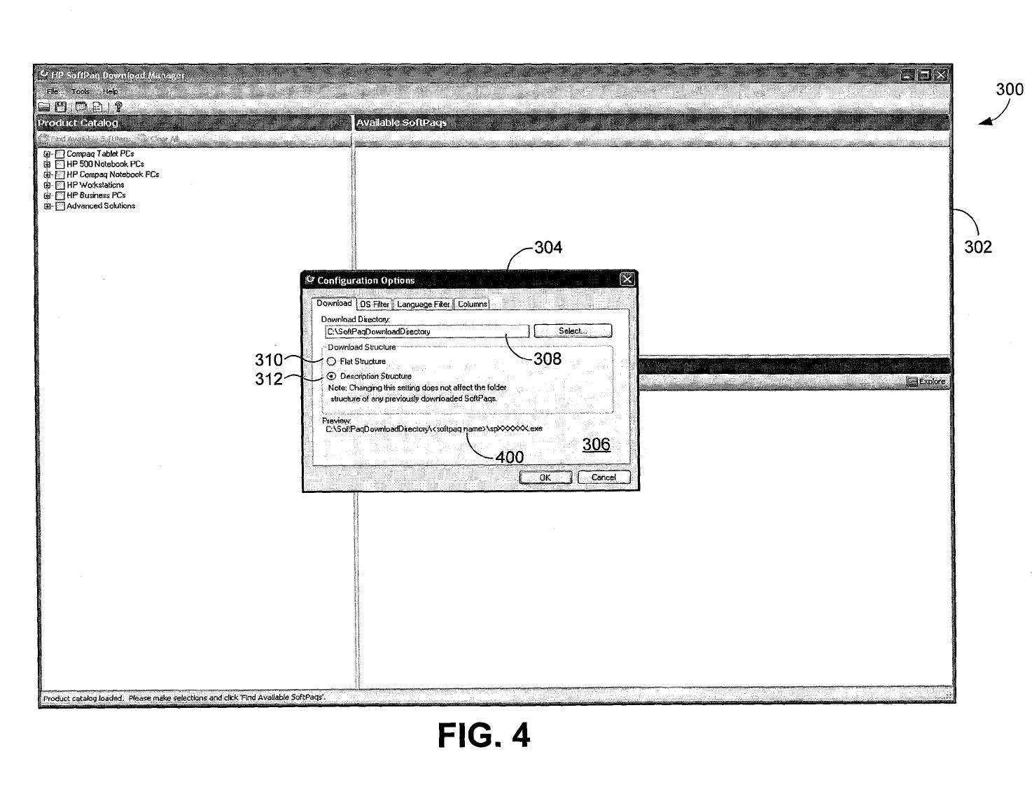

Contained within the configuration options dialog box 304 are multiple pages, each comprising its own tab that can be selected to access the page to which the tab pertains. A download page 306 is shown selected in FIG. 3. On that page 306, the user can specify a directory options 308 on the user's computer to which downloaded software is to be stored as well as a download structure. In the illustrated embodiment, the download structure comprises a flat structure 310 and a description structure 312. When the flat structure 310 is selected, all downloaded software will be stored together within the specified directory 308. A preview 314 of the format of such a structure is identified on the page 306 in FIG. 3. When the description structure 312 is selected however, the downloaded software will be stored within separate folders within the directory 308 that each pertain to a specific downloaded software package title. A preview 400 of the format of such a structure is illustrated on the page 306 in FIG. 4. Notably, other download structures can be used. For example, the software can be downloaded into folders arranged by product, operating system, language, or other relevant attributes.

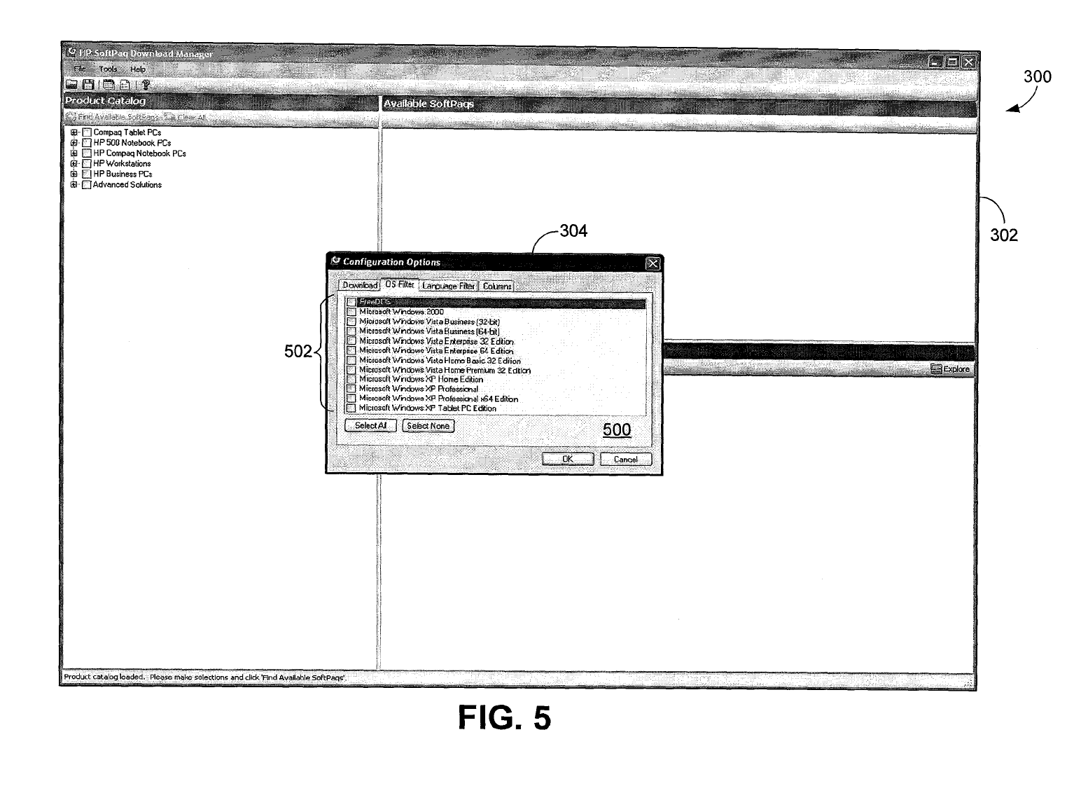

With reference next to FIG. 5, illustrated is an operating system filter page 500 of the configuration option dialog box 304. Presented within the operating system filter page 500 for selection are multiple operating systems 502 that have been installed on one or more of the products of the manufacturer. If the user is an individual who is seeking software for his or her computer, the user would select the operating system that his or her computer runs to enable filtering out (i.e., exclusion) of software of the database 202 that is incompatible with that operating system. If the user is an IT manager who is seeking software for multiple computers, the user would select the one or more operating systems run on those computers to likewise filter out software that is incompatible with those operating systems.

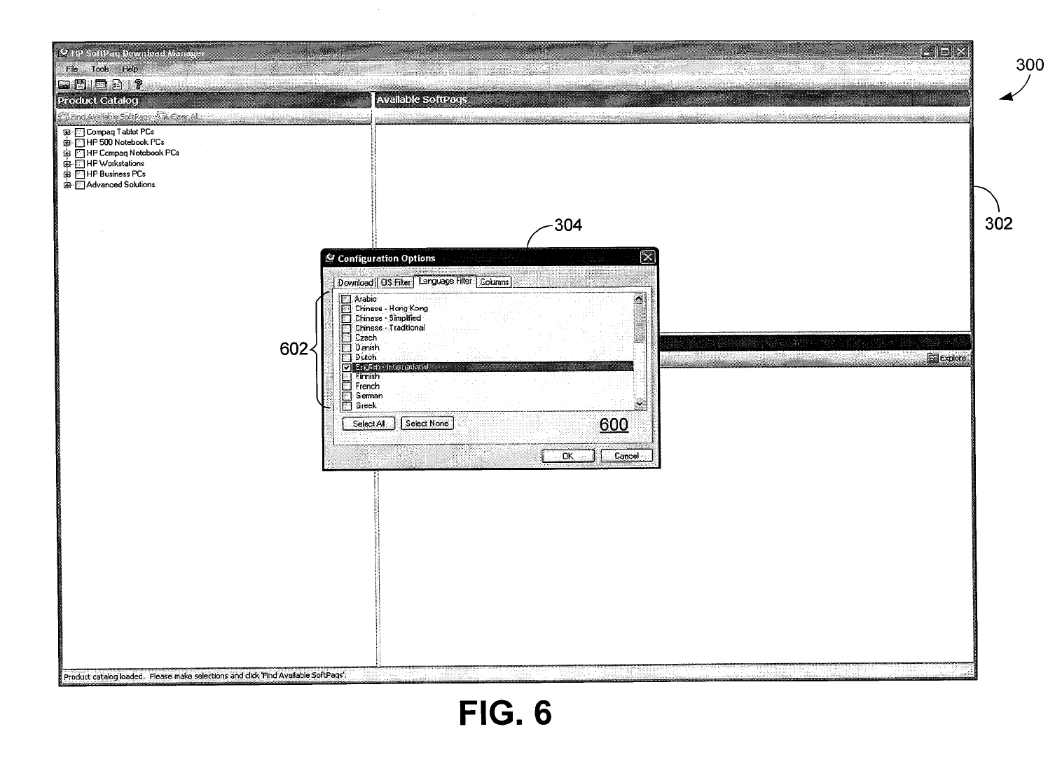

Turning to FIG. 6, illustrated is a language filter page 600 of the configuration option dialog box 304. Presented within the language filter page 600 for selection are multiple languages 602 for which the user's product or products may be configured. Typically, the individual user would select the single language he or she speaks and for which his or her computer is configured, while the IT manager would select the language or languages for which the computers he or she manages are configured.

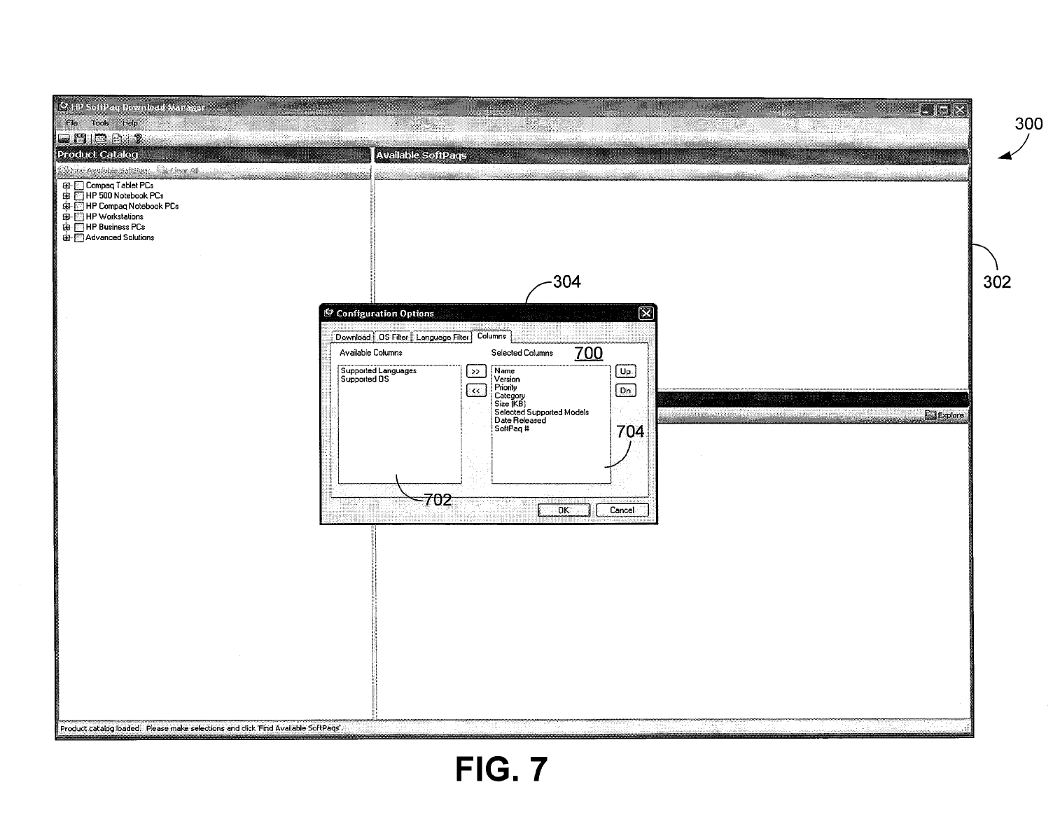

Illustrated in FIG. 7 is a attribute options page 700 of the configuration option dialog box 304. Presented within the attribute options page 700 for selection are multiple software package attributes, which will be arranged in various columns of the user interface, that pertain to the various software packages that will be presented to the user as being available for download. In the example of FIG. 7, those attributes include the name, version, priority, category, size, selected supported models, date released, number, supported languages, and supported operating systems of the software packages. As shown in FIG. 7, the attributes options page 700 can include an available columns box 702 and a selected columns box 704 with which the user can select the various attributes such that those attributes will or will not be presented to the user in association with the available software packages.

Once the user has made his or her selections in relation to the download directory, operating system(s), language(s), and attributes to view, the user has completed a configuration process that will exclude various software packages from a list of software packages that will be presented to the user as being available for download. Such exclusion or filtering is desirable given that, as mentioned above, the database 202 may comprise all software available for download for each product produced by the manufacturer. When the manufacturer is a large company that produces many products, the amount of software can be very large. Therefore, filtering removes inapplicable software is from the universe of available software for the user, thereby making it easier for the user to locate the needed or desired software.

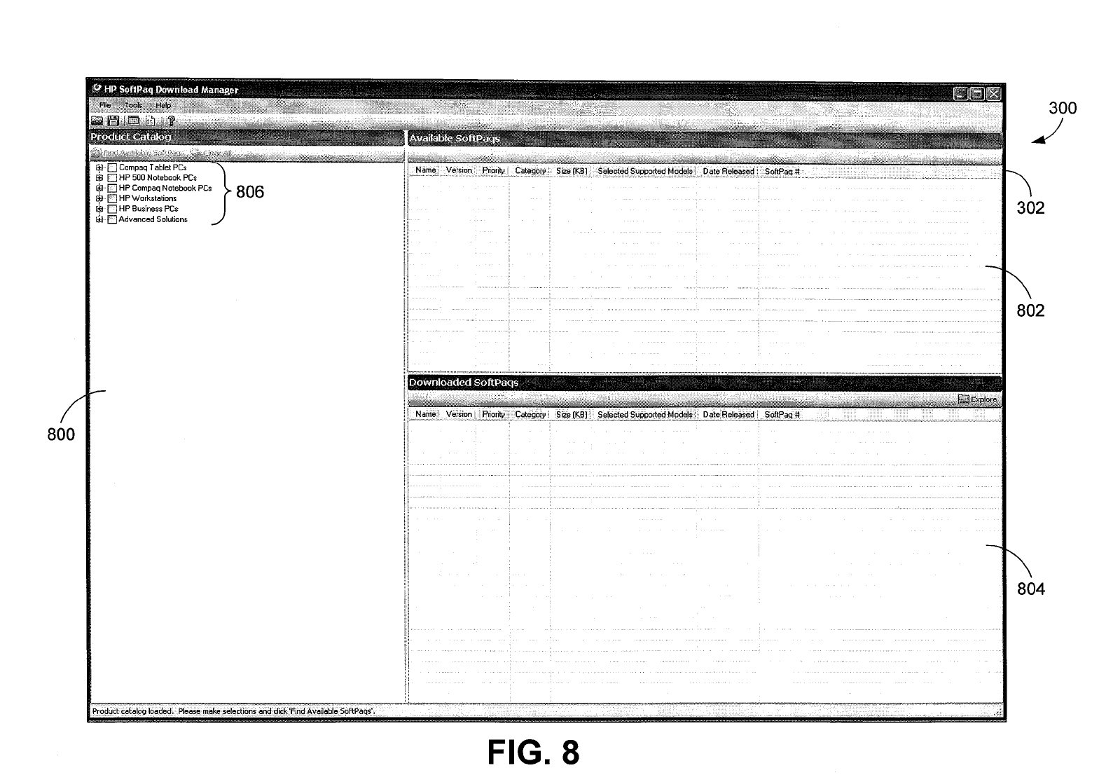

FIG. 8 illustrates the main window 302 of the software manager 208 after the above-described configuration process has been completed. As shown in FIG. 8, the main window 302 comprises three subwindows, including a product catalog window 800, an available SoftPaqs window 802, and a downloaded SoftPaqs window 804. The product catalog window 800 contains a list of all of the products of the manufacturer for which software is available for download from the database 202. In the embodiment illustrated in FIG. 8, those products comprise various computers divided into multiple categories 806 that include tablet PCs, notebook

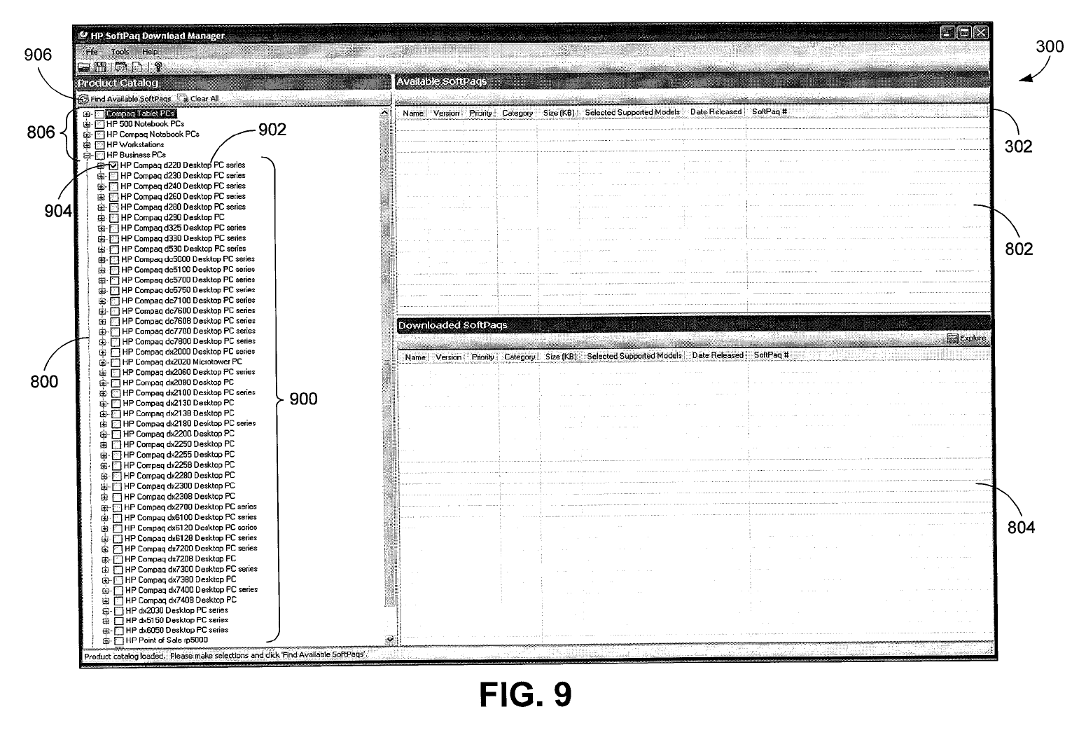

PCs, workstations, business PCs (i.e., desktops), and advanced solutions (e.g., blade computers. etc.). Each of the categories 806 can be expanded. An example of such expansion is shown in FIG. 9, in which the “HP Business PCs” category 806 has been expanded to reveal multiple specific product series 900 that fall within that category. As is apparent from the “+” symbols adjacent the various series 900, further expansion can be obtained as to each series to reveal specific products within the series (not shown).

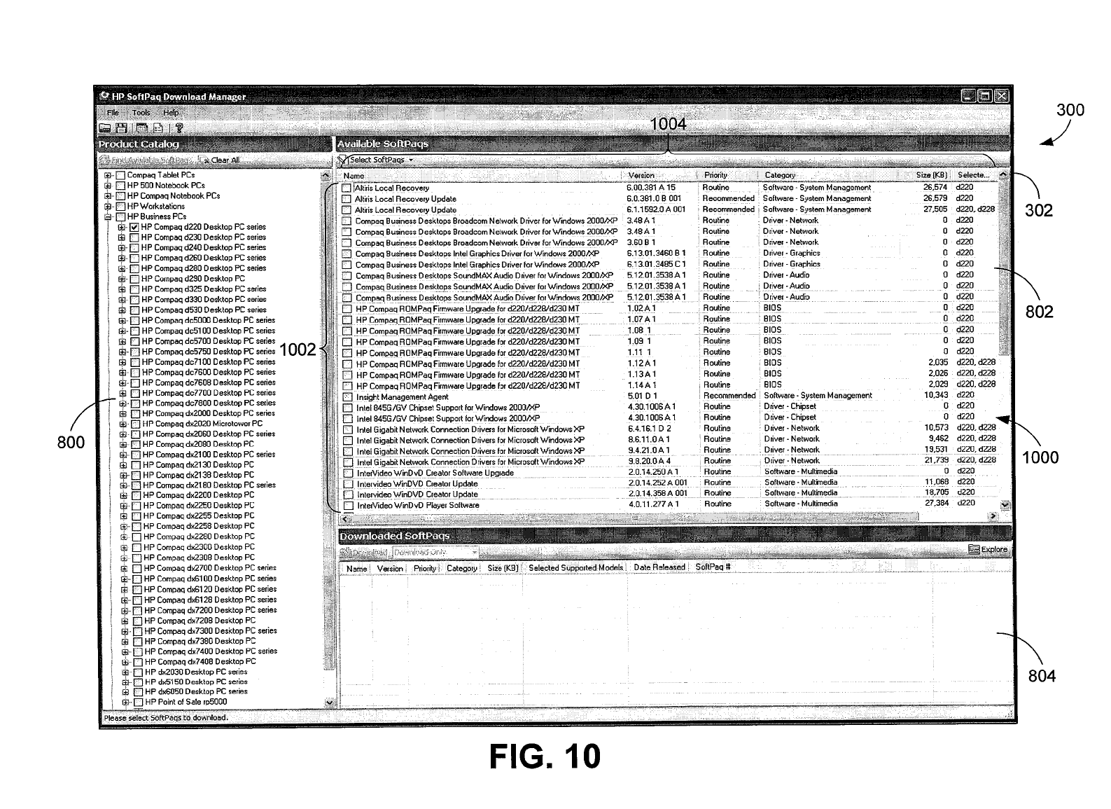

With further reference to FIG. 9, the HP Compaq d220 Desktop PC series 902 has been selected within the product catalog window 800 by checking an associated check box 904. Through such selection, the user will be able to view all software that is available for download for that product as filtered by the operating system(s) and language(s) specified by the user in the configuration process described above in relation to FIGS. 5 and 6. Although the HP Compaq d220 Desktop PC series 902 is shown as being selected in FIG. 9, it is noted that that selection has been made for purposes of example only. Moreover, multiple products may be selected if desired. Regardless of the particular selection, once a selection has been made a “Find Available SoftPaqs” button 906 becomes enabled. Once that button 906 has been selected, the download manager 208 presents the user with all of the available software for the selected product or products, again as filtered by the operating system(s) and language(s) identified during the configuration process. Such presentation is illustrated in FIG. 10.

As indicated in FIG. 10, multiple software packages or “SoftPaqs” 1000 available for download are presented to the user in the available Softpaqs window 802. As is apparent from FIG. 10, each SoftPaq 1000 is described within a row 1002 of the available SoftPaqs window 802 and each row comprises information about the attributes of the SoftPaq arranged by columns 1004. Visible in FIG. 10 are columns 1004 that describe the name, version, priority, category, size, and selected supported models of the identified SoftPaqs 1000. Significantly, the various SoftPegs 1000 identified within the available Softpaqs window 802 are limited to those that is available for the products the user selected and the configuration(s) the user specified.

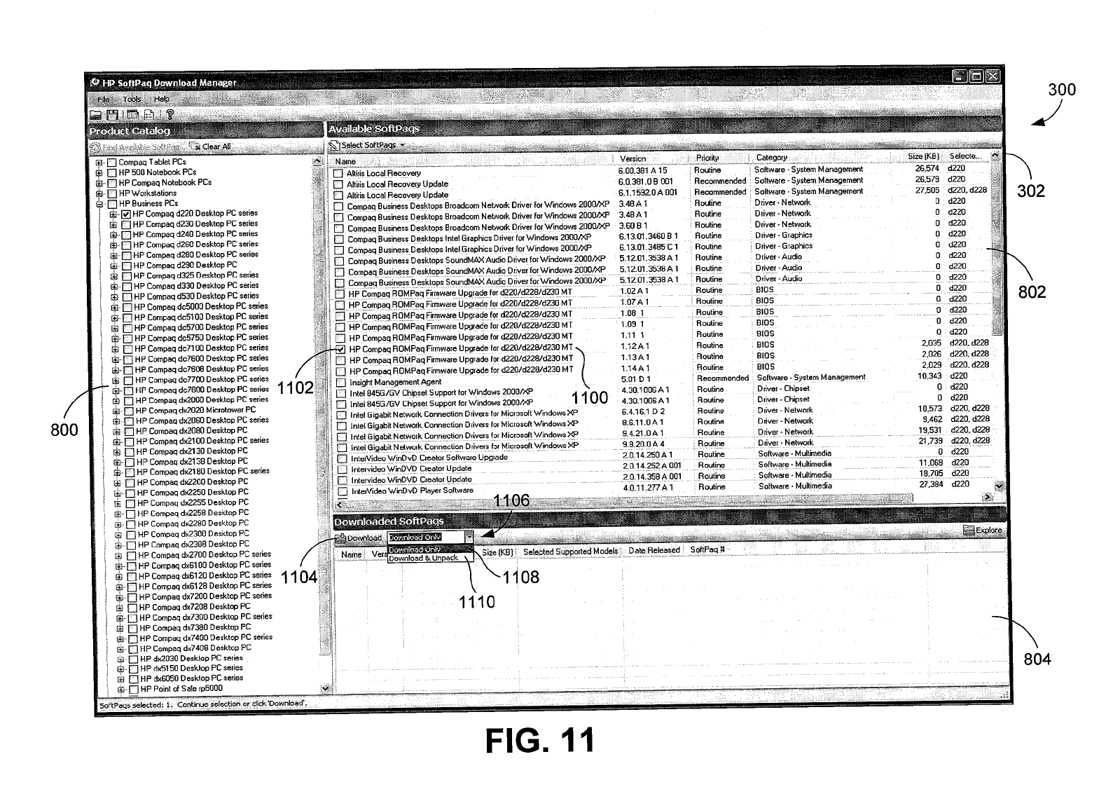

With reference next to FIG. 11, the “HP Compaq ROMPaq Firmware Upgrade for d220/d228/d230 MT” SoftPaq 1100 has been selected by checking a checkbox 1102. Again, that selection is illustrated for purposes of example only. Therefore, alternative selections can be made, which may comprise selection of multiple

SoftPaqs 1000 that can pertain to multiple different products. Regardless, once a selection has been made, a “Download” button 1104 of the downloaded SoftPaqs window 804 becomes enabled and therefore may be selected. When that button 1104 is selected, the selected SoftPaq(s) 1000 will be downloaded from the database 202 to the user's computer. As is further shown in FIG. 11, a dropdown menu 1106 is also presented in the downloaded SoftPaqs window 804 with which the user can specify “download only” 1108 in which case the SoftPaq(s) will only be downloaded or “download and unpack” 1110 in which case the SoftPaq(s) will be downloaded, opened, and the contents (i.e., Individual files) of the downloaded SoftPaq(s) are unpacked.

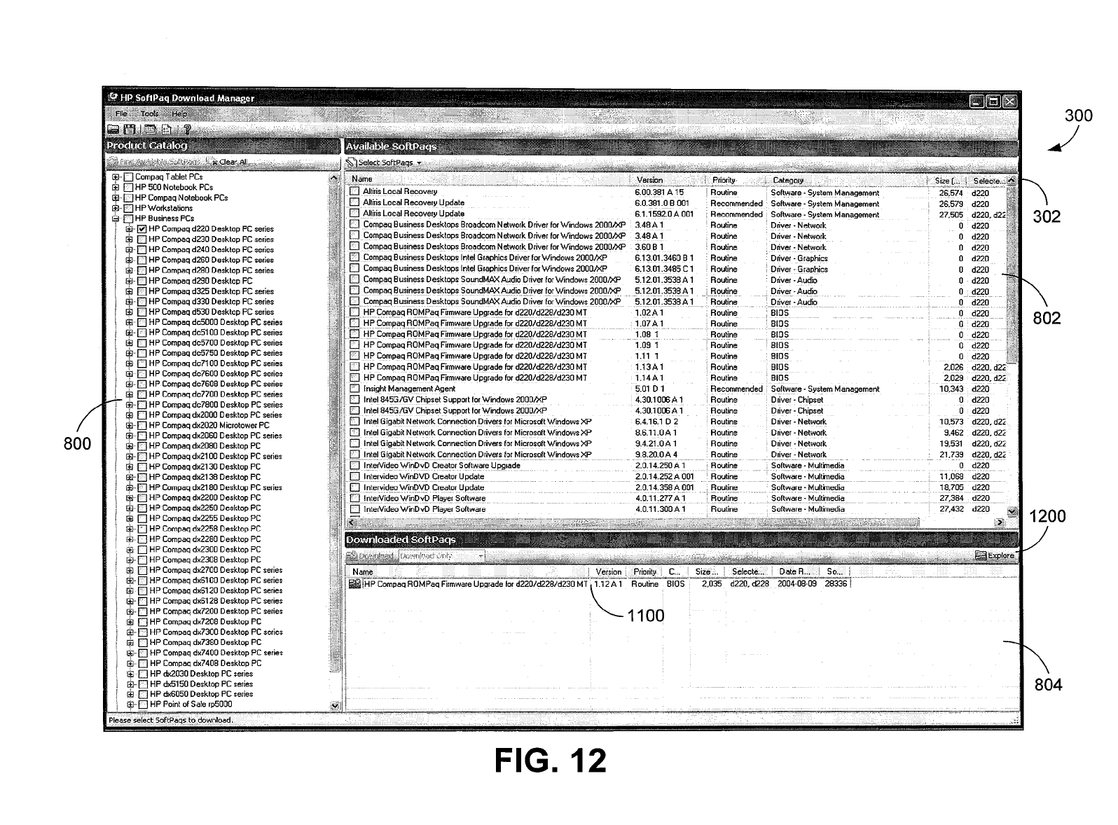

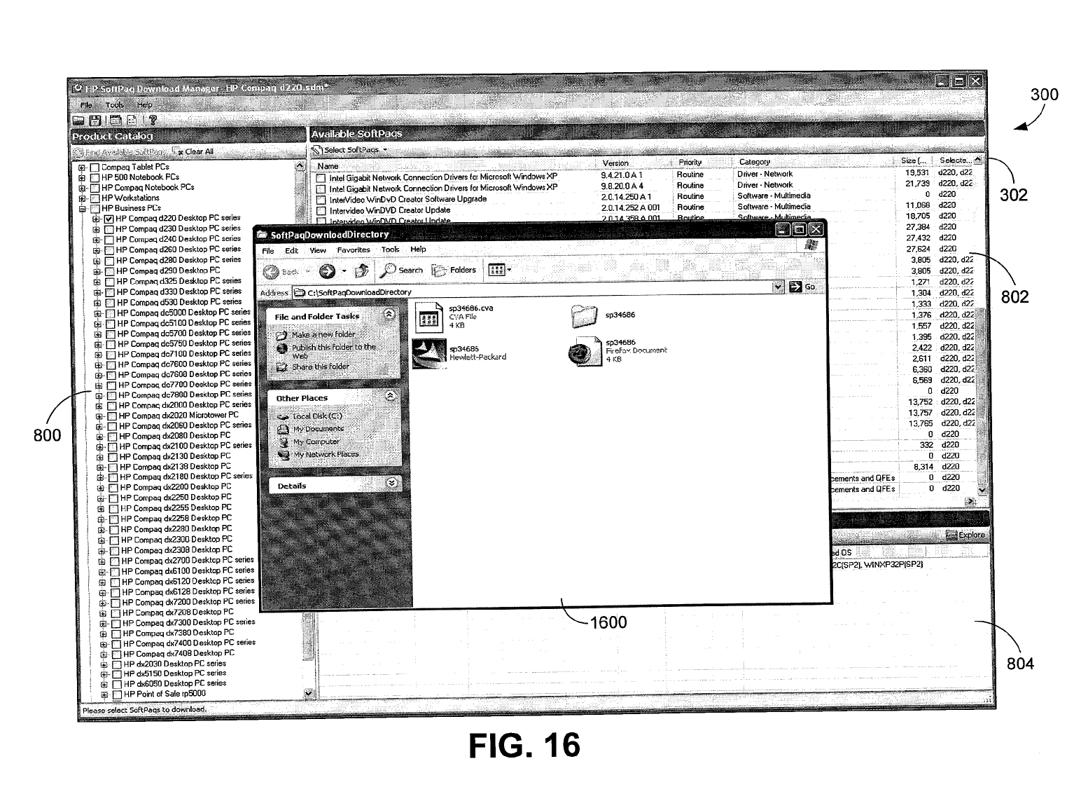

Once downloading has been completed, the SoftPaq(s) 1000 that had been selected will be identified in the downloaded SoftPaqs window 804 to communicate to the user that downloading has been completed. In the example of FIG. 12, only the “HP Compaq RomPaq Firmware Upgrade for d220/d228/d230 MT” Softpaq 1100 has been downloaded and therefore is identified in the downloaded SoftPaqs window 804. At this point, that SoftPaq 1100 is stored within the directory that was identified by the user in the configuration process described in relation to FIG. 3. To facilitate location of the SoftPaq(s) 1100, the downloaded SoftPaqs window 804 comprises an “Explore” button 1200 that, when selected, pulls up a file management window (see FIG. 16) for the download directory.

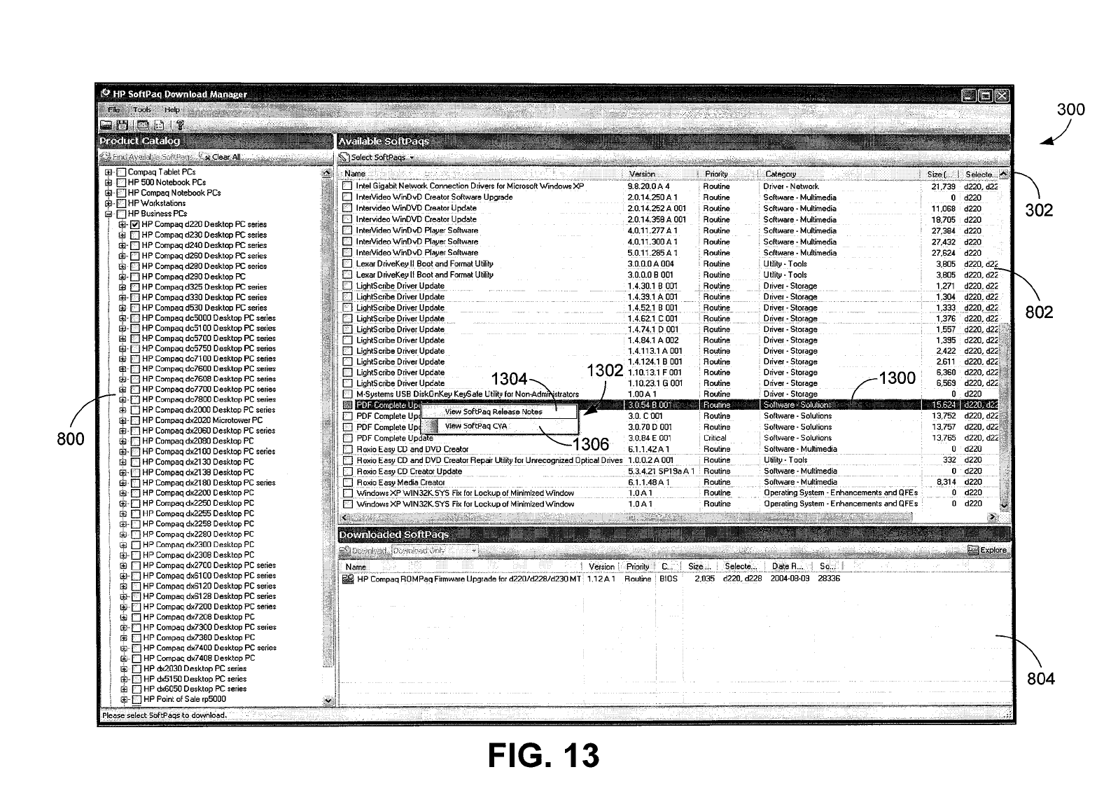

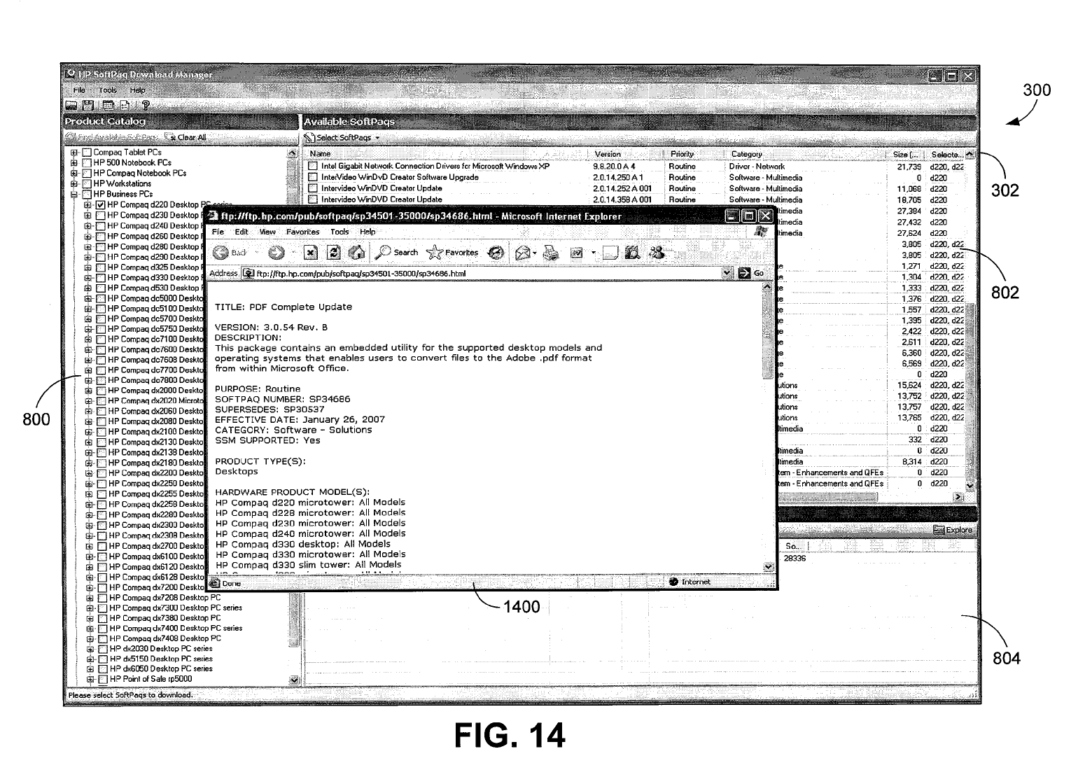

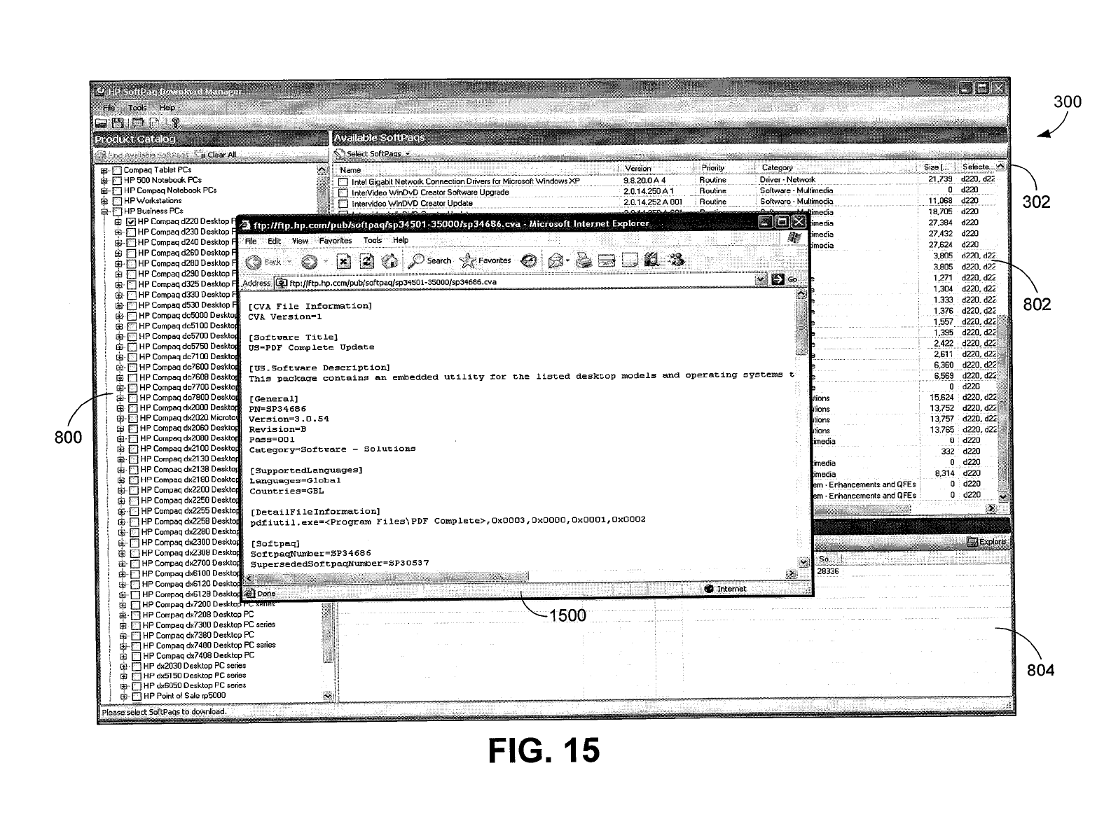

In addition to SoftPaqs, additional associated files may be downloaded. For example, the SoftPaqs may comprise one or both of associated release notes and an associated CVA file. With reference to FIG. 13, the user can determine whether such associated files exist by right clicking on a given SoftPaq 1000 within the available SoftPaqs window 802. As shown in FIG. 13 with reference to the “PDF Complete Update” SoftPaq 1300, such right clicking pulls up a dropdown menu 1302 from which the user can select a “View SoftPaq Release Notes” option 1304 or a “View SoftPaq CVA” option 1306. Selection of either option 1304, 1306 results in presentation of a dialog box that contains the relevant information (i.e., the release notes or the CVA file). FIG. 14 illustrates a first dialog box 1400 that comprises the release notes for the ‘PDF Complete Update” SoftPaq 1300, while FIG. 15 illustrates a second dialog box 1500 that comprises the CVA file for the “PDF Complete Update” SoftPaq. As described above, the user directly access the downloads by selection of the “Explore” button 1200. With reference to FIG. 16, a file management window 1600 has been opened after selection of the “Explore” button 1200. That window 1600 reveals that the “PDF Complete Update” SoftPaq (i.e., sp34686), the release notes for that SoftPaq (i.e., the Firefox Document), and the CVA file for that SoftPaq (i.e., “sp34686.cva”) have been downloaded to the user's selected directory.

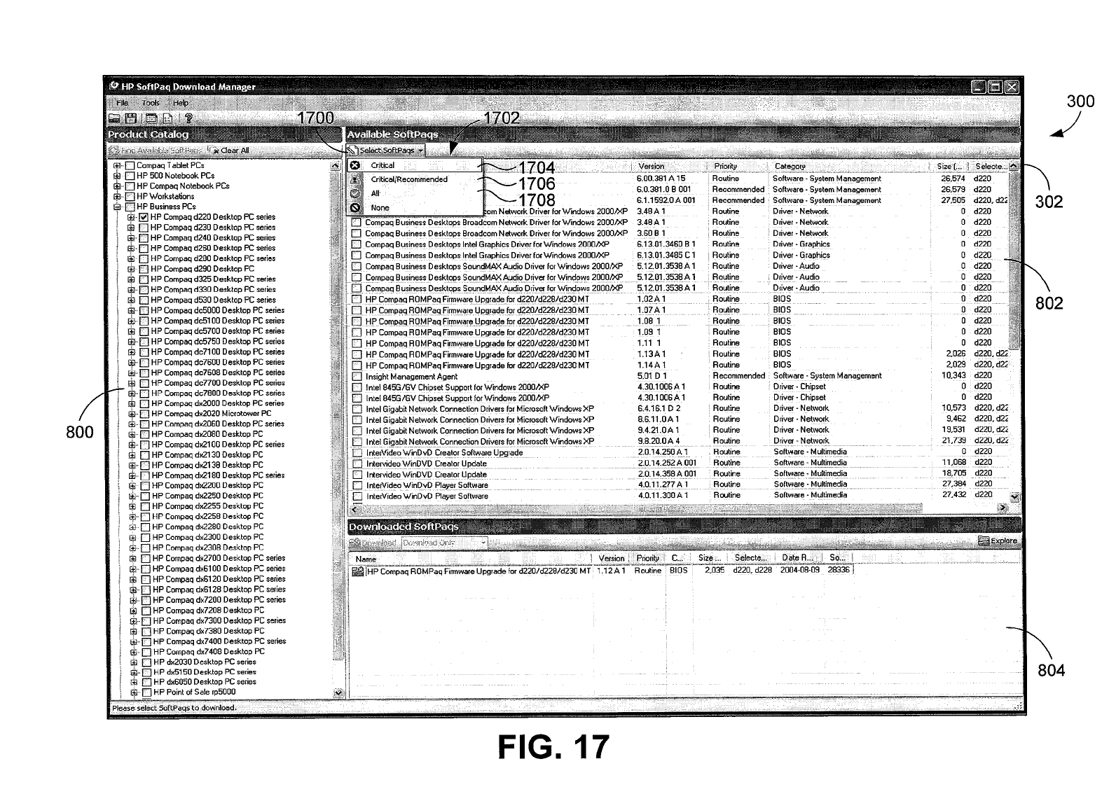

In addition to reducing the number of SoftPaqs 1000 presented to the user with the above-described filtering, the user can be further assisted in finding desired SoftPaqs by calling the user's attention to the various SoftPaqs that pertain to a particular category. Specifically, when the user selects a “Select SoftPaqs” button 1700 identified in FIG. 17, a dropdown menu 1702 appears that identifies specific categories or types of SoftPaqs, including critical 1704, critical and recommended 1706, or all 1708. When the user selects one of those categories the SoftPaqs 1000 that pertain to that category are checked for the user. Accordingly, if the user is, for example, seeking the critical updates/patches for his or her selected product and platform, that software will be highlighted for the user in the available SoftPaqs window 802 with checkmarks.

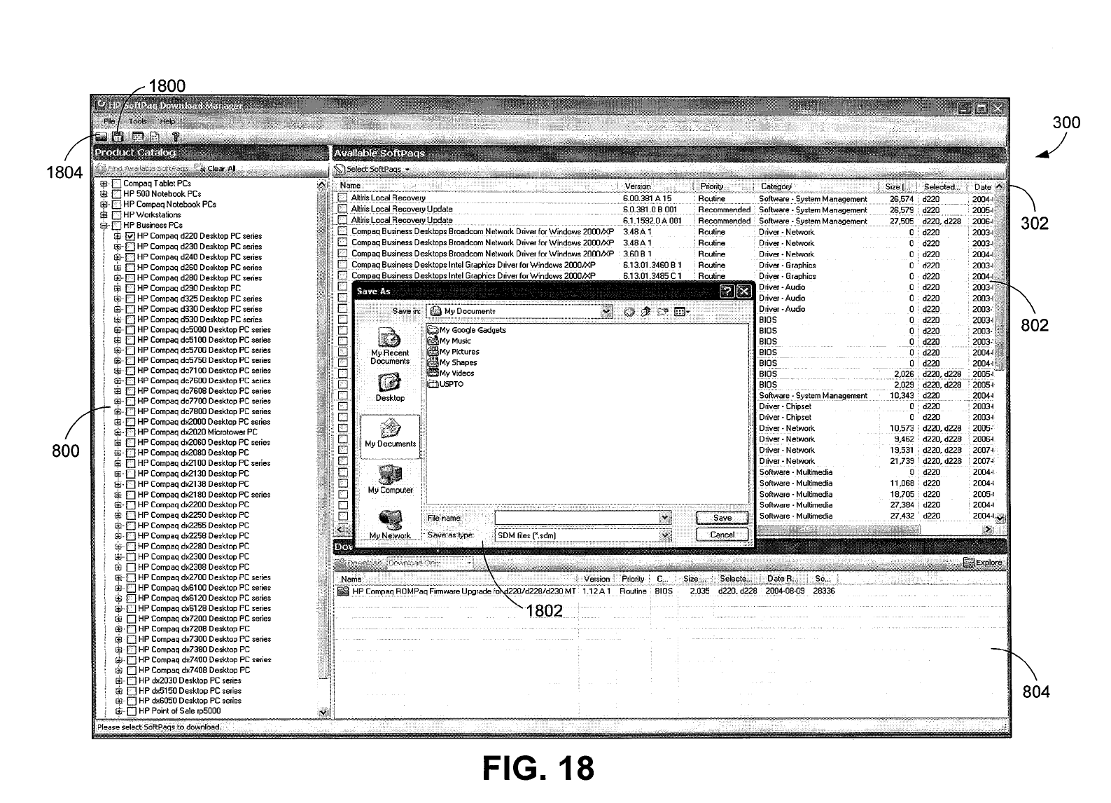

Often, the various products, operating systems, and languages selections will be the same for the user each or at least multiple times the user uses the SoftPaq download manager 208. In view of that, the download manager 208 facilitates saving of the user's selections as a configuration. Such an action is illustrated in FIG. 18 in which a save button 1800 has been selected so as to cause a “Save As” dialog box 1802 to appear. The user can then select an appropriate location at which to save the configuration. Notably, the user can save separate configurations for each product for which software may be later desired. Alternatively, the user can save a global configuration pertinent to all products that the user manages. Regardless, once a configuration has been saved, it can later be retrieved using an open button 1804.

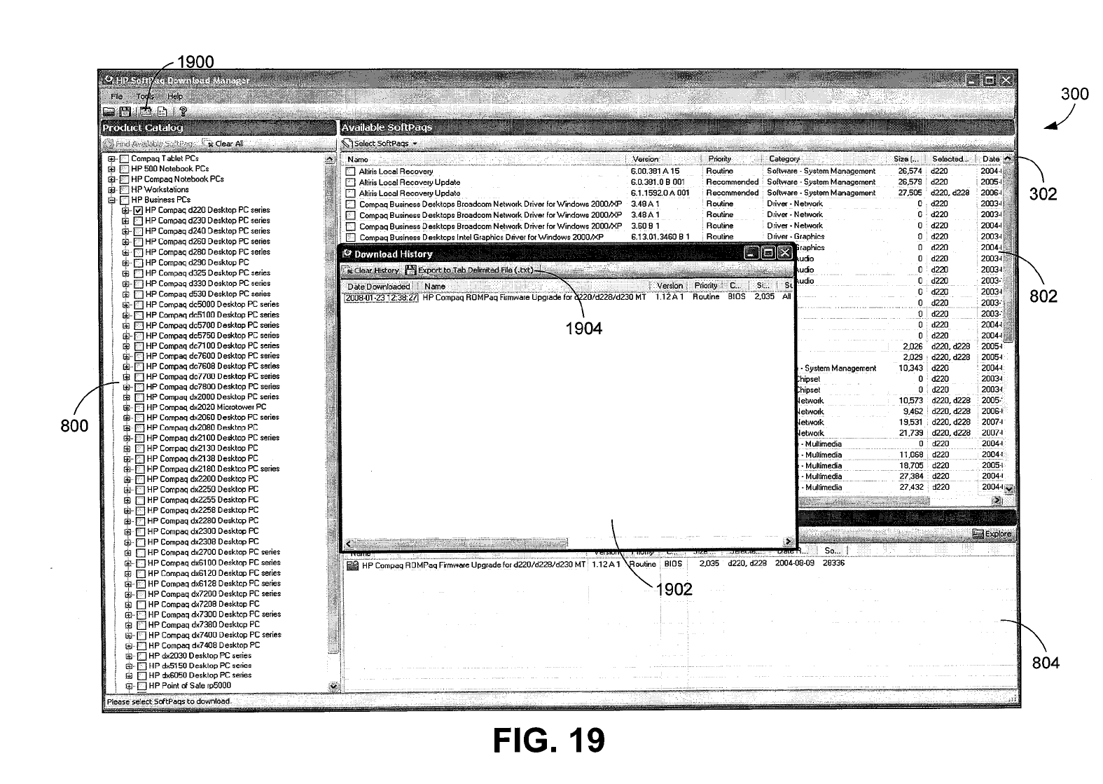

With reference next to FIG. 19, also provided on the main page 302 is a download history button 1900 that, when selected, causes a download history dialog box 1902 to appear. As indicated in FIG. 19, that dialog box 1902 identifies the various SoftPaqs that the user has downloaded and when. Such history may be particularly useful to IT managers who are responsible for managing many different products and, therefore, may be required to frequently download SoftPaqs. Included with the dialog box 1902 is an “Export to Tab Delimited File (.txt)” button 1904 that enables the user to export the history within the dialog box into a desired spreadsheet program or database.

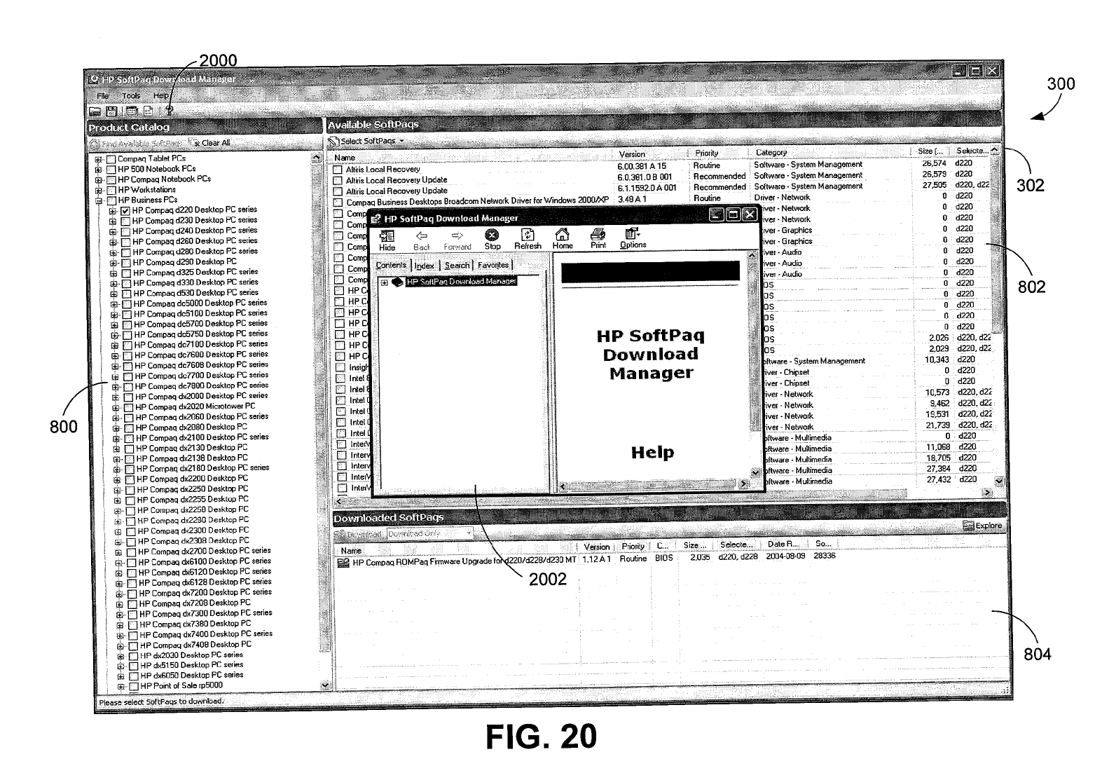

Turning to FIG. 20, further provided on the main page 302 is a help button 2000 that, when selected, causes a help dialog box 2002 to appear.

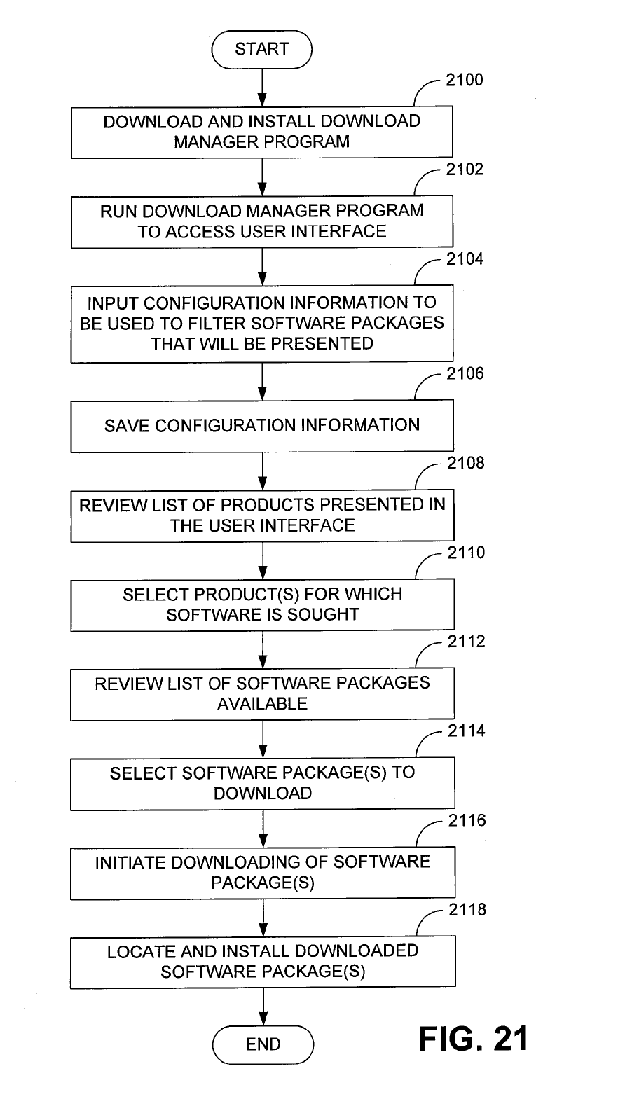

FIG. 21 illustrates an example method for locating and downloading software. Beginning with block 2100, a download manager program, such as the SoftPaq download manager 208 of FIG. 2, is downloaded and installed on the user's computer. As described above, the download manager program can, for example, be located at and downloaded from a web site hosted by or on the behalf of a manufacturer of the product(s) for which software is sought. Once the download manager program has been downloaded, it can be run on the user computer so that the user can access a user interface of the program, as indicated in block 2102. An example of such a user interface has been described above in relation to FIGS. 3-20.

Next, with reference to block 2104, the user can input configuration information to be used to filter software packages that will be presented to the user for selection. As described above, the number of software packages that are available for download may be large in cases in which the manufacturer produces many different products. The number that are presented to the user can be reduced, however, by only presenting software packages intended for products having the same configuration or configurations specified by the user. As is further described above, such configuration information can include the operating system(s) the user's product(s) run and the language(s) for which the product(s) is/are configured. The user can, optionally, save the configuration information that he or she inputs, as indicated in block 2106, so that similar filtering can be performed In later software downloading sessions.

After the configuration information has been input, the user is presented with a list of products in the user interface for which there are software packages available for download. The user can therefore review the list of products (block 2108) and select the one or more products for which the user is seeking software (block 2110). Once the product or products have been selected, the user is presented with a list of software packages available for download. Notably, the list comprises a consolidated listing of software packages that results after filtering according to the product(s), the operating system(s), and the language(s) selected by the user. Accordingly, the number of available software packages presented to the user will typically be far less than the total number of software packages-available, thereby making identification of the desired software package(s) easier for the user.

Referring to block 2112, the user can review the list of available software packages and then, as indicated in block 2114, select those that are needed or desired. At that point, the user can initiate downloading of selected the software package(s), as indicated in block 2116. Once such downloading has been completed, the user can locate the downloaded software package(s) on his or her computer and install the software package(s), as indicated in block 2118. In some cases, the user can quickly locate the downloaded software package(s) by selecting the ‘Explore” button 1200 identified in FIG. 12. Regardless the software package(s) can be installed on the user computer and/or another computer or other product, depending upon the nature of the software it/they contain.

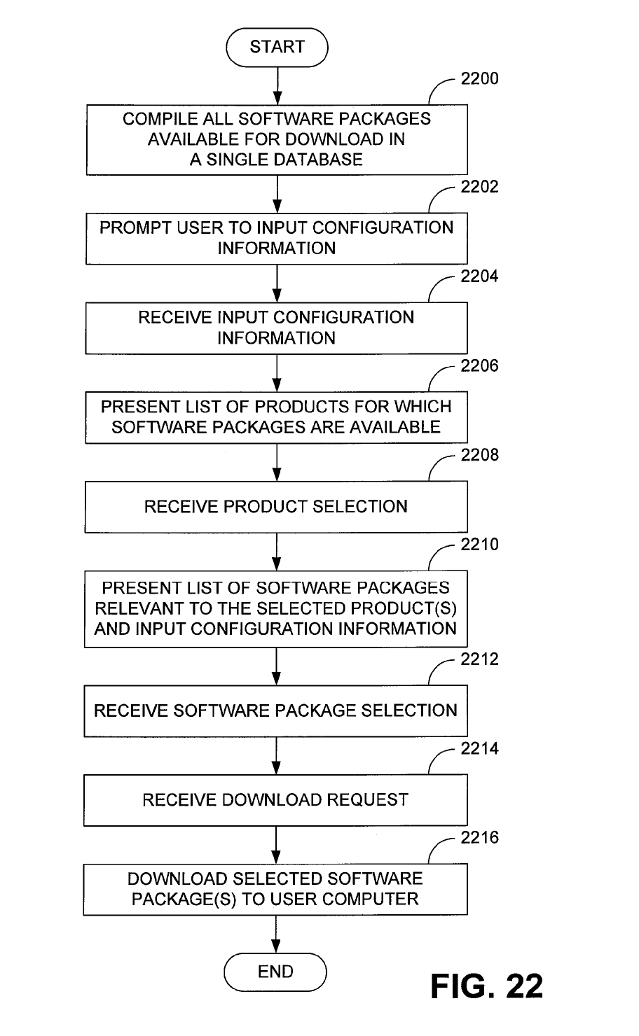

FIG. 22 illustrates an example method for providing software that can, for example, be performed by the SoftPaq download manager 208 in conjunction with the FTP site 206 and SoftPaq database 202. Beginning with block 2200, all software packages available for download are compiled in a single database. Once the database has been completed, the download manager prompts the user to input configuration information, such as the operating system(s) and/or language(s) that apply to the product or products for which the user is seeking software, as indicated in block 2202. Notably, the user has the option of identifying multiple operating systems and/or multiple languages such that the user can be presented with software packages intended for multiple products that run different operating systems and/or are configured to use different languages. As described above, prompting can be performed using a configuration dialog box 304 identified in FIGS. 5 and 6.

Referring next to block 2204, the download manager receives configuration information input by the user and, as indicated in block 2206, presents a list of products for which software packages are available. The list of products can, in some embodiments, comprise an updated list obtained from the database. Next, with reference to block 2208, the download manager receives the user's product selection. Notably, the selection can comprise selection of multiple products such that the user can be simultaneously presented with software packages for multiple different products. Once the product selection has been made, the download manager searches the database for software and then presents the user with a list of software packages relevant to the selected product(s), operating system(s), and language(s), as indicated in block 2210. As mentioned above, the size of the list is may be significantly smaller than the list of all available software packages contained in the database due to the filtering that has been performed, thereby making identification of the needed or desired software package(s) easier on the user.

The software package selection is then received, as indicated in block 2212. The software package selection may be a selection of one or multiple software packages, either for a single or multiple products. Accordingly, the download manager enables the user to simultaneously download multiple software packages, potentially for multiple different products, at the same time, which may significantly reduce the time and effort that must be expended to obtain all of the software. With reference next to block 2214, a download request can be received and, with reference to block 2216, the selected software package or packages can be downloaded from the database to the user computer.

As can be appreciated from the above disclosure, the availability of the SoftPaq database, the FTP site, and the SoftPaq download manager greatly simplifies the process of locating software that is needed or desired for one or more products of a given manufacturer. First, by containing all available software within a single, directly-accessible database, users need not waste time searching the manufacturer's web site to locate the software. Second, by enabling the user to filter the software available for download not only by product but also by operating system and language, users can much more easily identify the software they wish to download. Third, by enabling the user to simultaneously search for, as well as simultaneously download, software for multiple products, the tedium of separately hunting for software for each individual product is obviated.

Various programs (logic) have been described herein. It is noted that those programs can be stored on any computer-readable medium for use by or in connection with any computer-related system or method. In the context of this document, a “computer-readable medium” is an electronic, magnetic, optical, or other physical device or means that contains or stores a computer program for use by or in connection with a computer-related system or method. Those programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Claimed are:

1. A method for providing software, the method comprising:
compiling software available for download in a database;
prompting a user to select a product for which software is sought;
receiving the user product selection; and
presenting to the user software available for download, the software being intended for installation on the product that the user selected.

2. The method of claim 1, wherein compiling software comprises compiling all available software for all software-based products produced by a given manufacturer in a single database.

3. The method of claim 1, wherein the database comprises an extensible markup language database.

4. The method of claim 1, wherein prompting the user to select a product comprises prompting the user to select a computer product.

5. The method of claim 1, wherein receiving the user product selection comprises receiving selection of multiple products.

6. The method of claim 1, further comprising filtering the software relative to the product selected by the user so as to exclude software from the database that is not intended for use on that product.

7. The method of claim 1, further comprising prompting the user to identify an operating system and a language and receiving the operating system and language identifications.

8. The method of claim 7, further comprising filtering the software relative to the operating system and language identifications so as to exclude software from the database that is not compatible with that operating system and that language.

9. The method of claim 1, further comprising receiving a software selection from the user and downloading the selected software from the database to a computer of the user.

10. The method of claim 9, wherein receiving a software selection comprises simultaneously receiving selection of multiple software packages and wherein downloading comprises downloading each software package to the user computer in response to receipt of a single download command.

11. The method of claim 9, wherein receiving a software selection comprises simultaneously receiving selection of multiple software packages intended for installation on multiple different products and simultaneously downloading each software package to the user computer.

12. Computer-readable media that store a system for providing software, the system comprising:
a database that contains software packages for multiple different products produced by a manufacturer;
a file transfer site that facilitates download of the software packages from the database to user computers via a network; and
a software download manager that executes on the user computers and assists users in locating and downloading software, the software download manager being configured to:
prompt a user to select a product for which software is sought;
receive the user product selection; and
present to the user software available for download, the software being intended for installation on the product that the user selected.

13. The computer-readable media of claim 12, wherein the database comprises all available software for all software-based products produced by the manufacturer.

14. The computer-readable media of claim 12, wherein the file transfer site comprises a file transfer protocol (FTP) site.

15. The computer-readable media of claim 12, wherein the software download manager is configured to receive selection of multiple products.

16. The computer-readable media of claim 12, wherein the software download manager is further configured to filter the software relative to the product selected by the user so as to exclude software from the database that is not intended for use on that product.

17. The computer-readable media of claim 12, wherein the software download manager is further configured to prompt the user to identify an operating system and a language and to receive the operating system and language identifications.

18. The computer-readable media of claim 12, wherein the software download manager is further configured to filter the software relative to the operating system and language identifications so as to exclude software from the database that is not compatible with that operating system and that language.

19. The computer-readable media of claim 12, wherein the software download manager is further configured to receive a software selection from the user and download the selected software to a computer of the user.

20. The computer-readable media of claim 12, wherein the software download manager is further configured to simultaneously receive selection of multiple software packages and simultaneously download each software package to the user computer in response to receipt of a single download command.

21. The computer-readable media of claim 12, wherein the software download manager is further configured to simultaneously receive selection of multiple software packages intended for installation on multiple different products and to simultaneously download each software package to the user computer.

22. A computer comprising:
a processor; and
memory that stores a software download manager that assists a user in locating and downloading software from a remote database, the software download manager being configured to prompt the user to select a product for which software is sought, to receive the user product selection, to filter the software within the database relative to the product selected by the user so as to exclude software from the database that is not intended for use on that product, and to present the remaining software to the user for selection.

23. The computer of claim 22, wherein the software download manager is further configured to prompt the user to identify an operating system and a language and to further filter the software within the database relative to the operating system and language identifications so as to further exclude software from the database that is not compatible with that operating system and that language.

24. The computer of claim 22, wherein the software download manager is further configured to receive a software selection from the user and download the selected software to a computer of the user.

25. The computer of claim 22, wherein the software download manager is further configured to simultaneously receive selection of multiple software packages and simultaneously download each software package to the user computer.
